(19) United States
(12) Patent Application Publication
(10) Pub. No.: US 2010/0017713 A1
(43) Pub. Date: Jan. 21, 2010

(54) Content Management Apparatus and Content Management Method

(75) Inventor: Yoshihiro Igarashi, Ome-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/391,996

(22) Filed: Feb. 24, 2009

(30) Foreign Application Priority Data
Jul. 18, 2008 (JP) 2008-187194

(51) Int. Cl. G06F 7/06; G06F 3/048; G06F 17/30

(52) U.S. Cl. 715/716; 707/5; 707/E17.009; 707/E17.016; 707/E17.045; 707/E17.044

(57) ABSTRACT

According to one embodiment, a content management apparatus according to one embodiment of the invention includes a first acquisition module configured to acquire a predetermined content, a storage module configured to store the predetermined content in a storage unit, a detection module configured to detect the presence/absence of related content related to the predetermined content, and relevance between the predetermined content and content other than the predetermined content stored in the storage unit, a display information output module configured to output display information required to display information of unacquired related content which is related content related to the predetermined content and is not stored in the storage unit, and a second acquisition module configured to acquire an unacquired related content based on an acquisition instruction of the unacquired related content.

### CROSS-REFERENCE TO RELATED APPLICATIONS

This application is based upon and claims the benefit of priority from Japanese Patent Application No. 2008-187194, filed Jul. 18, 2008, the entire contents of which are incorporated herein by reference.

### BACKGROUND

1. Field

One embodiment of the present invention relates to a content management apparatus and content management method, which acquire content from media such as an SD® card, and store the acquired content in a large-capacity storage device such as a hard disc.

2. Description of the Related Art

In recent years, video recording/playback apparatuses which mount large-capacity storage devices such as hard discs have prevailed remarkably, and a large number of content items can be stored in a large-capacity storage device. A large number of content items stored in the large-capacity storage device are displayed as a list, and the user can watch desired content by selecting it from the displayed list of content.

Jpn. Pat. Appln. KOKAI Publication No. 2004-343520 (reference 1) discloses a technique for simply managing series content of a large number of content items stored in a large-capacity storage device. More specifically, this technique manages series content using series IDs, episode numbers, and video recording statuses. As for series content, the technique displays a list of content with the same series ID all together. Whether or not content has already been recorded are recorded for respective episode numbers, and a content of an episode number which has not been recorded yet is surely recorded at the next broadcast chance.

The technique disclosed in reference 1 mentioned above covers broadcast content. That is, an unrecorded content cannot be acquired until it is broadcast next time.

By contrast, a technique that allows the user to download a desired content via a network, and to watch the downloaded content has been proposed. Or a technique (streaming) that allows the user to start watching while desired content is received via a network has been proposed.

For example, when the user watches a predetermined content stored in a large-capacity storage device, he or she may often want to watch related content which is related to this predetermined content. In such a case, it is difficult for the user to recognize whether or not related content is available, whether or not related content can be acquired by, e.g., downloading if it is available, or whether or not related content has already been stored in the large-capacity storage unit.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is a view showing the first example of list display of content;

FIG. 2 is a view showing the second example of list display of content;

FIG. 3 is a view showing the third example of list display of content;

FIG. 4 is a view showing a screen that displays related content items all together according to an embodiment of the invention;

FIG. 5 is a view showing an episode display layer according to the embodiment;

FIG. 6 is a view showing a display screen including a graph indicating the watched and acquired states of episodes according to the embodiment; and

FIG. 7 is a schematic block diagram showing the arrangement of a content management system according to the embodiment.

### DETAILED DESCRIPTION

Various embodiments according to the invention will be described hereinafter with reference to the accompanying drawings. In general, a content management apparatus according to one embodiment of the invention comprises a first acquisition module configured to acquire a predetermined content, a storage module configured to store the predetermined content in a storage unit, a detection module configured to detect the presence/absence of related content related to the predetermined content, and relevance between the predetermined content and content other than the predetermined content stored in the storage unit, a display information output module configured to output, based on the detection result, first display information required to display information of unacquired related content which is related content related to the predetermined content and is not stored in the storage unit, and a second acquisition module configured to acquire an unacquired related content based on an acquisition instruction of the unacquired related content.

One embodiment of the invention will be described hereinafter with reference to the accompanying drawings.

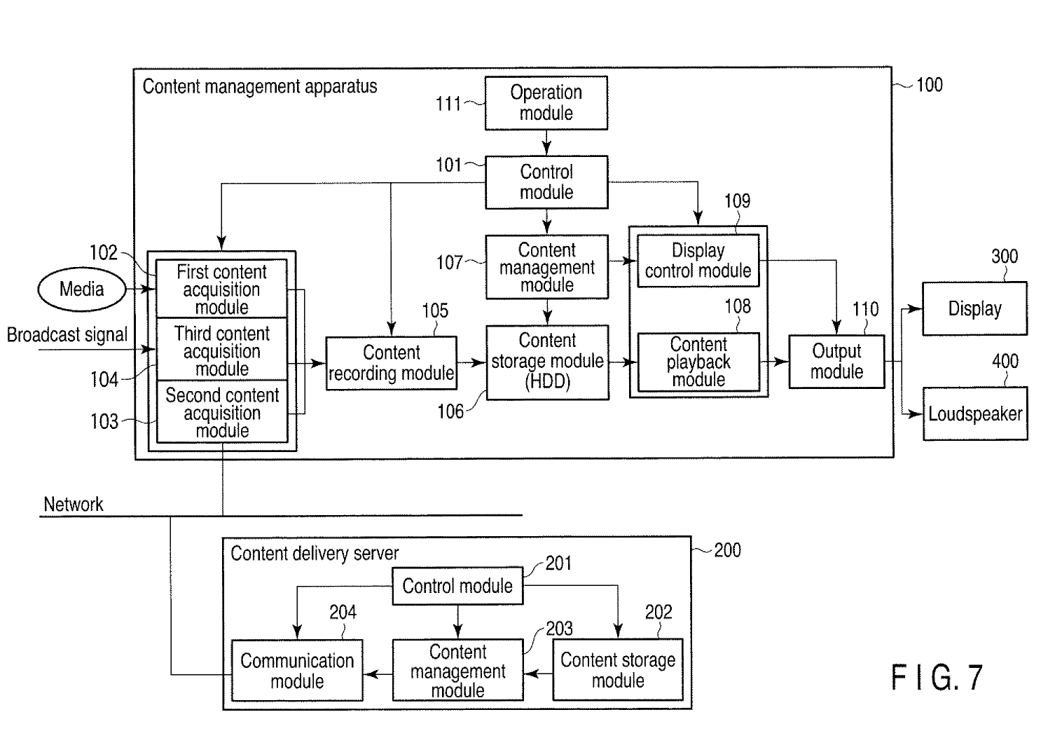

FIG. 7 is a schematic block diagram showing the arrangement of a content management system according to one embodiment of the invention. As shown in FIG. 7, a content management system includes a content management apparatus 100 and content delivery server 200. The content management apparatus 100 acquires and records content, and is implemented by, for example, a hard disc recorder, personal computer, or set-top box. The content delivery server 200 is implemented by, e.g., a network server managed by a content provider.

The content management apparatus 100 comprises a control module 101, first content acquisition module 102, second content acquisition module 103, third content acquisition module 104, content recording module 105, content storage module 106, content management module 107, content playback module 108, display control module 109, output module 110, and operation module 111.

For example, the control module 101 controls acquisition of content, recording of content, and playback of recorded content based on instructions input via the operation module (operation panel or remote controller) 111. The first content acquisition module 102 is a media reader which reads data from media such as an SD card, and reads content stored in an SD card and the like. The second content acquisition module 103 is, for example, a network communication unit, which downloads content from the server 200 via a network. The third content acquisition module 104 is a digital tuner or the like, and acquires content from a digital broadcast.

The content recording module 105 records content acquired by the first, second, or third content acquisition module 102, 103, or 104 in the content storage module 106 based on an instruction from the control module 101. The content storage module 106 comprises, e.g., a hard disc, solid-state drive (SSD), or SD card. The content management module 107 manages content stored in the content storage module 106, and provides content information associated with the content to the display control module 109. The content information includes information such as titles, playback times, directors, years of creation, performers, and the like of content.

The content playback module 108 plays back content stored in the content storage module 106 based on an instruction from the control module 101. Or the content playback module 108 plays back content acquired by the content acquisition module 104 (from a digital broadcast) based on an instruction from the control module 101. The output module 110 outputs a content video signal that reproduces content on a display 300, and outputs a content audio signal that reproduces content from a loudspeaker 400. The display control module 109 outputs content display information required to display the content information provided from the content management module 107 on the display 300. The output module 110 outputs the content display information to the display 300. As a result, the user can recognize content stored in the content storage module 106 via the display 300. Note that the output module 110 can also output composite information of the content video signal and content display information, In this case, a screen in a state in which content information is superimposed on a content video picture is displayed (so-called on-screen display).

The content delivery server 200 comprises a control module 201, content storage module 202, content management module 203, and communication module 204.

For example, the control module 201 controls delivery of content. The content storage module 202 stores a large number of content items to be delivered. The content management module 203 manages a large number of content items stored in the content storage module 202. The communication module 204 transmits content requested from the content management apparatus 100 to the content management apparatus 100.

With the above arrangement, the content management apparatus 100 can acquire content stored in media such as an SD card, can request the content delivery server 200 to transmit desired content and acquire the desired content delivered from the content delivery server 200 by downloading, and can play back acquired content.

Content management by the content management apparatus 100 will be described in detail below. As described above, the content management apparatus 100 can acquire content from various media (SD card, DVD, and the like). That is, the content management apparatus 100 can acquire purchased or rental content. Furthermore, the content management apparatus 100 can also acquire content from a digital broadcast. The content management apparatus 100 can store acquired content in the content storage module 106. The capacities of storage devices like the content storage module 106 are increasing year by year, and the number of content items to be saved by each individual user is increasing accordingly. When the user plays back desired content from a large number of content items saved in the content management apparatus 100 or manipulates (deletes, copies, or moves) files corresponding to the desired content, the content management apparatus 100 displays a list of titles and the like of a large number of content items saved in itself on the screen in response to a user operation. The content management apparatus 100 of this embodiment can simply display a list of titles and the like of content, and can also plainly display unacquired related content which is related to acquired content.

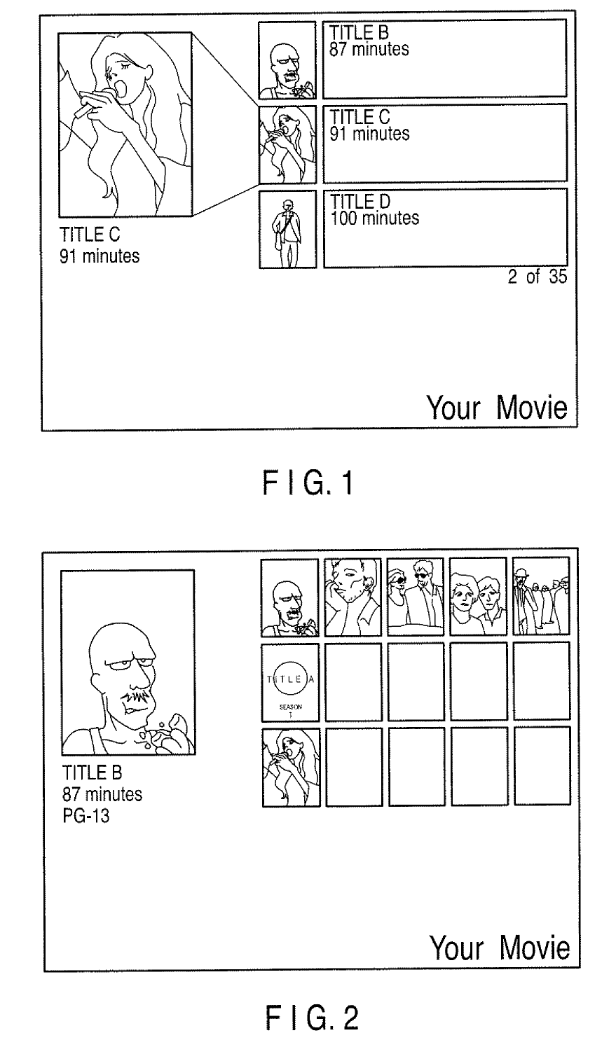

FIG. 1 is a view showing the first example of list display of content. Icons (cover photos) of respective content items and simple comments are displayed on the screen. Likewise, FIG. 2 is a view showing the second example of list display of content, and a large number of icons are laid out in a tile pattern by omitting comments of respective content items.

When the number of content items becomes very large, and when the user plays back desired content or manipulates files of them, he or she visually observes a large number of icons and comments displayed as a list.

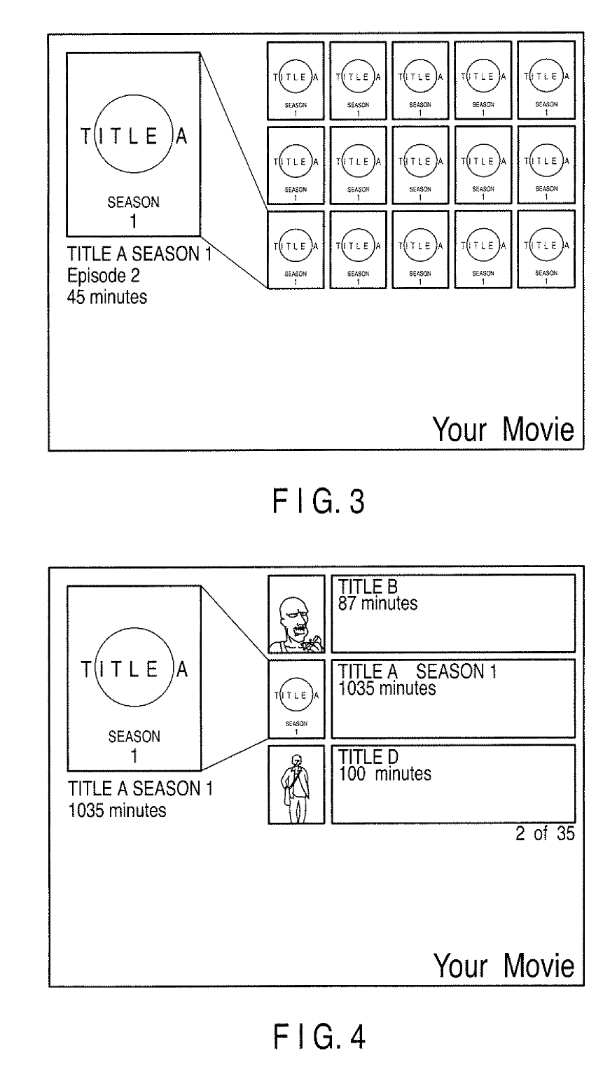

For example, when a list of a serial drama including 23 episodes for one season is to be displayed, a large number of icons and comments are presented on the screen, as shown in FIG. 3. The user visually observes all of them.

In order to improve such list display that does not effectively use a screen region and has poor visibility, the content management apparatus 100 expresses related content using one icon all together, and also expresses an independent content using one icon. For example, the content management apparatus 100 displays a list of an icon that gathers related content together and that corresponding to independent content, as shown in FIG. 4. In other words, the content management apparatus 100 outputs, to the display 300, display information required to display a list of an icon that gathers related content together and that corresponding to independent content, as shown in FIG. 4.

FIG. 4 is a view showing an example of display that gathers related content together. As shown in FIG. 4, an icon with “TITLE A SEASON 1” means one season of a serial drama, and represents 23 episodes included in one season. An icon that represents a plurality of episodes in this way will be referred to as an episode container hereinafter.

Since the content management apparatus 100 adopts the concept of an episode container, the number of icons can be reduced, and the screen region can be effectively used. As a result, the visibility can be improved greatly.

On a screen that displays an episode container icon (to be referred to as an “episode container display layer” hereinafter), when the user selects the episode container icon via the operation module 111, the content management apparatus 100 presents the next screen (see FIG. 5). In other words, the content management apparatus 100 outputs display information required to present the next screen (see FIG. 5) to the display 300.

FIG. 5 shows an example of an episode display layer. As shown in FIG. 5, on the episode display layer, display of the episode container disappears, while 23 episodes are displayed using independent icons and comments. The user can confirm and select each individual episode via the operation module 111, and can start watching.

In order to implement the aforementioned display, the following preconditions (1 to 5) are required. Also, a further precondition (6) is desirably added.

1) Unique IDs are assigned to respective episodes. This unique ID will be referred to as an IDEn hereinafter. A content includes an IDEn as metadata. Alternatively, a management file acquired simultaneously with a content associates a file of the content and IDEn with each other.

2) A unique ID is also assigned to each episode container. This unique ID will be referred to as an IDC hereinafter. For example, respective content items include information required to generate an episode container (e.g., representative video pictures for one season). Alternatively, a management file acquired simultaneously with content includes information required to generate an episode container. The episode container includes the IDC as metadata. Alternatively, the management file acquired simultaneously with content associates the IDC and a file of the episode container with each other.

3) All episodes included in the episode container are associated with the episode container. The episode container includes an IDE1, IDE2, IDE3, . . . of respective episodes as metadata. Alternatively, a management file acquired simultaneously with content associates the IDE1, IDE2, IDE3, . . . with the IDC.

4) Upon displaying a list of content on the episode container display layer, the icon and comment of the episode container (IDC) are displayed with reference to the association of precondition 3. That is, the display control module 109 outputs display information required to display the icon and comment of the episode container (IDC) on the display 300. However, the icons and comments of respective episodes (IDE1, IDE2, IDE3, . . . ) are not displayed (FIG. 4).

5) When the user selects the episode container (IDC) via the operation module 111 to display the episode display layer, the icons and comments of respective episodes (IDE1, IDE2, IDE3, . . . ) are displayed. That is, the display control module 109 outputs display information required to display the icons and comments of respective episodes (IDE1, IDE2, IDE3, . . . ) on the display 300. However, the icon and comment of the episode container are not displayed (FIG. 5).

6) It is desired to simultaneously supply the episodes and episode container, as described in preconditions 1 to 3. That is, the content management apparatus 100 simultaneously acquires the episodes and episode container. Alternatively, the content management apparatus 100 (content management module 107) may create an episode container, and may associate respective episodes with the episode container.

As a result, the content management apparatus 100 (content management module 107) can detect the presence/absence of related content (IDE2, IDE3, . . . ) related to, e.g., acquired content of the IDE1 based on the IDE1, IDE2, IDE3, . . . included in the episode container. Furthermore, the content management apparatus 100 can also detect relevance between the acquired content of the IDE1 and content other than the content of the IDE1 which is already stored in the content storage module 106.

The content management apparatus 100 can display the statuses of respective episodes on the episode display layer such as modes A to C below.

A) When the user has not watched an acquired predetermined content (acquired predetermined episode) yet, information indicating an unwatched content (“New” shown in FIG. 5) is displayed in an icon of the acquired predetermined content (acquired predetermined episode).

B) When the user has already watched an acquired predetermined content (acquired predetermined episode), information indicating a watched content (“Watched” shown in FIG. 5) is displayed in an icon of the acquired predetermined content (acquired predetermined episode).

C) A list of icons of unacquired predetermined content (unacquired predetermined episodes) related to the acquired content is displayed. For example, as shown in FIG. 5, a message “Get Missing Episodes?” T is displayed, and a list of unacquired predetermined content (unacquired predetermined episodes) corresponding to SEASON 1 of TITLE A is displayed. Furthermore, as shown in FIG. 5, a message “Get Related Content?” is displayed, and a list of unacquired predetermined content, extra content, soundtracks, and the like corresponding to SEASON 2 or later of TITLE A is displayed.

Primary related content and secondary related content are defined as follows to help easy understanding of the following description.

That is, content of an identical title and identical season are defined as primary related content. For example, content corresponding to SEASON 1 of TITLE A is primary related content. That is, Episodes 1 to 23 of SEASON 1 of TITLE A are primary related content. Note that icons displayed in correspondence with the message “Get Missing Episodes?” shown in FIG. 5 indicate unacquired primary related content.

Related content other than primary related content is defined as secondary related content. For example, content corresponding to SEASON 1 of TITLE A, content corresponding to SEASON 2 or later of TITLE A, extra content, soundtracks, and the like are secondary related content. Alternatively, content corresponding to SEASON 1 of TITLE A, and content directed by the same director as that of TITLE A may be secondary related content. Note that icons displayed in correspondence with the message “Get Related Content?” shown in FIG. 5 indicate unacquired secondary related content.

Note that the content management module 107 of the content management apparatus 100 controls to record metadata indicating an unwatched content in a predetermined content or management file upon acquisition of the predetermined content. Likewise, the content management module 107 controls to record metadata indicating a watched content in a predetermined content or management file upon playing back the predetermined content. The display control module 109 generates display information required to display unwatched/watched information on the episode display layer with reference to data of unwatched/watched content.

The content management module 107 of the content management apparatus 100 can detect the presence of unacquired episodes by comparing the unique IDs of all content items saved in the content storage module 106 with episodes (IDE1 IDE2, IDE3, . . . ) included in the episode container.

The content management apparatus 100 can be connected to a line of the Internet or the like, and can acquire information associated with all related content related to acquired content by sending an inquiry to the content delivery server 200 via the Internet. As a result, the content management apparatus 100 can display a list of all related content related to acquired content.

For example, when the user selects an icon of an unacquired episode (primary related content) (an icon displayed in correspondence with the message “Get Missing Episodes?” shown in FIG. 5) via the operation module 111, the content management apparatus 100 sends an inquiry to the content delivery server 200 via the Internet to present an online shopping screen and to present detailed information of the unacquired episode. Furthermore, when the user selects purchase/rental of the unacquired episode via the operation module 111, the content management apparatus 100 (third content acquisition module 103) downloads the unacquired episode from the content delivery server 200 via the Internet. In this way, the user can know detailed information of the unacquired episode, and can purchase or rent the unacquired episode by a simple operation. Such delivery of unacquired episodes is effective for content suppliers as part of expansion of marketing.

Likewise, when the episode container includes unique IDs of related content items (video, music, etc.), the user can recognize detailed information of this related content via an online shopping screen, and can purchase or rent this related content. For example, when the user selects an icon of an unacquired content (secondary related content) (an icon displayed in correspondence with the message “Get Related Content?” shown in FIG. 5) via the operation module 111, the content management apparatus 100 sends an inquiry to the content delivery server 200 via the Internet to present an online shopping screen and to present detailed information of that unacquired content. Furthermore, when the user selects purchase or rental of the unacquired content via the operation module 111, the content management apparatus 100 downloads the unacquired content from the content delivery server 200 via the Internet. As a result, the user can know the detailed information of the unacquired content, and can purchase or rent the unacquired content by a simple operation. Such delivery of unacquired content is effective for content suppliers as part of expansion of marketing.

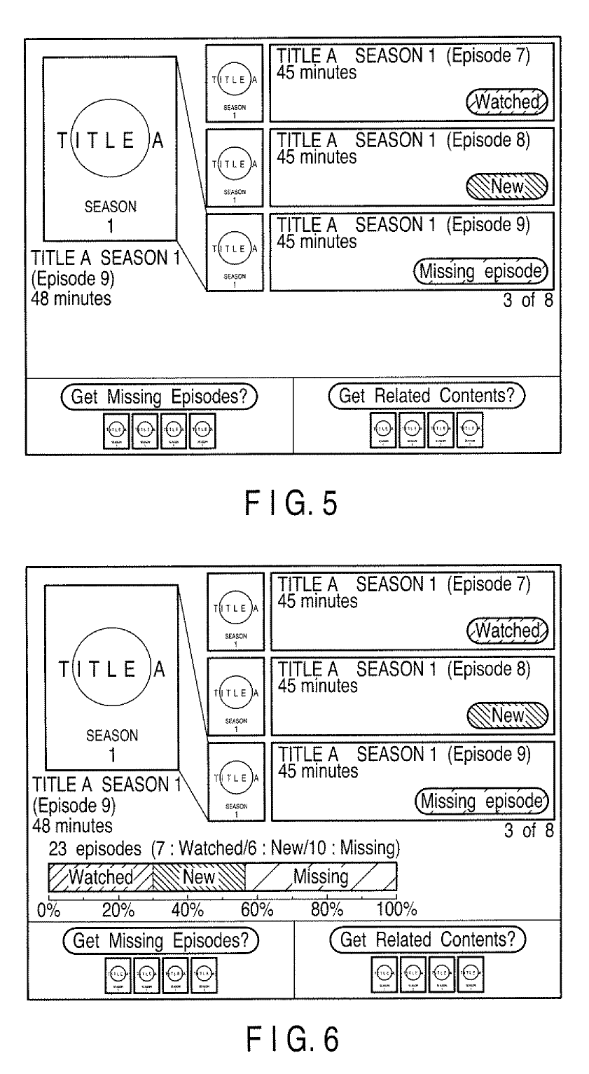

Furthermore, the content management apparatus 100 can display the watched and acquired states of, e.g., SEASON 1 of TITLE A as a graph, as shown in FIG. 6. In other words, the content management apparatus 100 outputs display information required to present the screen shown in FIG. 6 to the display 300. As a result, the user can recognize that he or she has already acquired episodes of about 60% (13 episodes) of the serial drama (23 episodes), but he or she has not acquired those of about 40% (10 episodes) yet. Furthermore, the user can recognize that he or she has already watched seven out of the acquired episodes, but he or she has not watched six episodes yet.

This embodiment will be summarized below.

1. A content management apparatus gathers a plurality of related content items together using an episode container, and outputs display information required to display one icon corresponding to this episode container.

2. The content management apparatus outputs display information required to display a list of icons of the plurality of related content items included in the episode container in response to selection of the icon corresponding to the episode container.

3. The content management apparatus outputs display information required to display acquired/unacquired statuses of respective content items and watched/unwatched information of respective content items on the list display of the icons of the plurality of related content items included in the episode container.

4. The content management apparatus outputs display information required to display information indicating watched, unwatched, unacquired states, and the like using a graph or the like of the plurality of related content items included in the episode container.

As described above, since the content management apparatus 100 adopts the concept of an episode container, a list of large quantities of video content items can be displayed while effectively using the screen region and maintaining high visibility. Also, since unacquired content (primary related content) of an identical season, and unacquired related content (secondary related content) are presented on the screen together, the user can easily purchase or rent this content. Furthermore, by presenting the statuses of respective content items using a graph, the user can recognize the watched statuses of a serial drama or the like.

The various modules of the device described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A content management apparatus comprising:
a first acquisition module configured to acquire a predetermined content;
a storage module configured to store the predetermined content in a storage unit;
a detection module configured to detect presence/absence of related content related to the predetermined content, and relevance between the predetermined content and content other than the predetermined content stored in the storage unit;
a display information output module configured to output, based on the detection result, first display information required to display information of unacquired related content which is the related content related to the predetermined content and is not stored in the storage unit; and
a second acquisition module configured to acquire the unacquired related content based on an acquisition instruction of the unacquired related content, and
wherein the display information output module outputs second display information required to display a ratio of acquired related content which has already been watched, acquired related content which has not been watched yet, and the unacquired related content.

2. The apparatus of claim 1, wherein the display information output module outputs, based on the detection result, third display information required to display information of the acquired related content which is the related content and is stored in the storage unit.

3. The apparatus of claim 2, wherein the third display information includes information indicating watched states of the acquired related content.

4. (canceled)

5. A content management apparatus comprising:
a detection module configured to detect relevance of content stored in a storage unit, and presence/absence of related content related to the content;
a display information output module configured to output, based on the detection result, first display information required to display a first item which indicates information of acquired related content stored in the storage unit together, and to output, in response to selection of the first item, second display information required to display information of the acquired related content and information of unacquired related content which is further related to the acquired related content and is not stored in the storage unit; and
an acquisition module configured to acquire the unacquired related content based on an acquisition instruction of the unacquired related content, and
wherein the display information output module outputs third display information required to display a ratio of the acquired related content which has already been watched, the acquired related content which has not been watched yet, and the unacquired related content.

6. (canceled)

7. The apparatus of claim 5, wherein the second display information includes information indicating watched states of the acquired related content.

8. (canceled)

9. A content management method comprising:
acquiring a predetermined content;
storing the predetermined content in a storage unit;
detecting presence/absence of related content related to the predetermined content, and relevance between the predetermined content and content other than the predetermined content stored in the storage unit;
outputting, based on the detection result, first display information required to display information of unacquired related content which is the related content related to the predetermined content and is not stored in the storage unit and second display information required to display a ratio of acquired related content which has already been watched, acquired related content which has not been watched yet, and the unacquired related content; and
acquiring the unacquired related content based on an acquisition instruction of the unacquired related content.
